(19) United States
(12) Patent Application Publication
(10) Pub. No.: US 2026/0076772 A1
(43) Pub. Date: Mar. 19, 2026

(54) TOOTH EXTRACTION TOOL AND METHOD OF USING THE SAME

(71) Applicant: Medenovate LLC, Irvine, CA (US)

(72) Inventors: Jerome Insurb Choe, Irvine, CA (US); Jisoo Choe, Irvine, CA (US); Jae Kim, Troy, MI (US)

(21) Appl. No.: 19/333,332

(22) Filed: Sep. 18, 2025

Related U.S. Application Data
(60) Provisional application No. 63/696,855, filed on Sep. 19, 2024.

(51) Int. Cl. A61C 3/02

(52) U.S. Cl. CPC A61C 3/02; A61C 2201/007

(57) ABSTRACT

A tooth extraction tool to sever through a periodontal ligament for atraumatic extraction of a tooth in humans is provided. The tool includes an elongated handle with two ends. The tool further includes a blade attached to one end of the elongated handle. The blade flexes to adapt to the shape of the periodontal ligament when the blade is vertically moved between the alveolar bone and the tooth to be extracted along selected tooth surfaces. The vertical movement of the blade relays an axial force to sever the periodontal ligament.

### CROSS-REFERENCE TO RELATED PATENT DOCUMENTS

This patent application claims the benefit of priority of U.S. Provisional Application No. 63/696,855, entitled “Novel Periodontal Knife (PeriNi) for Dental Procedures,” filed Sep. 19, 2024, which is hereby incorporated herein by reference in its entirety.

### TECHNICAL FIELD OF INVENTION

The present invention relates generally to the field of dental devices. Particularly, the present invention relates to a novel tooth extraction tool designed for efficiently and effectively extracting teeth. This tool assists dental practitioners in performing minimally invasive surgery or dental procedures for removing the tooth structures without damaging adjacent teeth, alveolar bone, surrounding soft tissues such as the gingiva, and buccal plate. The tooth extraction tool is configured in the form of a knife to cut through the periodontal ligament (PDL), significantly reducing the tooth's attachment force with the alveolar bone to enable a more controlled, atraumatic extraction of the subject tooth. A method for using the tooth extraction tool is also presented.

### BACKGROUND

Typically, tooth extraction remains one of the most invasive and traumatic procedures in dentistry. A number of prior art devices exist for the purpose of extracting a tooth. The most common are dental forceps, luxators, root tip picks, and elevators. These devices may be used in combination. Forceps can be used to pull the tooth, and elevators can be anchored to the alveolar bone to elevate the tooth. Luxators can loosen the connective tissue, and root tip picks can be used to anchor out the root tips. Use of dental forceps (also known as dental pliers) is most common and is typically machined from stainless steel. The use of such devices to extract teeth is often associated with pain and unpleasantness. The dental forceps include a pair of handles that are pivotally engaged with each other. Each handle has a jaw at one end, and the jaws may be moved toward or away from each other by manipulating the handles. Some dental forceps have straight jaws, others have angled jaws, and some have a combination of straight and angled jaws. Typically, the jaws are configured such that there is a slightly cupped shape proximate to the end of the jaws. The cupped region is provided to engage a tooth shape. The force needed to grip dental forceps and extract a permanent adult tooth can be surprisingly high for the dentist. Essentially, the required force for tooth extraction needs to overcome the connection of the periodontal ligaments and to widen the alveolar bone. An extraction procedure for an adult molar with two or three roots may often begin with a twisting rotational movement to try to loosen the roots. The rotational motion may be followed by a firm pulling motion. This results in pain and discomfort, as the tooth must be worked out, and often the use of such tools results in damage to the socket of the extracted tooth. Further, there is a high risk of damaging adjacent teeth, alveolar bone, surrounding soft tissues such as the gingiva, alveolar nerve, and buccal plate.

Further, the pressure applied during the procedure may potentially harm the inferior alveolar nerve or potentially cause a maxillary sinus complication. Additionally, applying brutal force to break tissue (periodontal ligament (PDL)) attachments before tooth extraction poses a significant risk to the tooth's structural integrity, as the force used to break the attachment is also applied to the tooth. In many cases, the reason for the extraction of the tooth is the structural weakness of the tooth itself (having caries, prior endodontic treatment, or fractures). There are many cases in extraction where the coronal structure of the tooth is missing. In such cases, the high force cannot be easily applied, so the supporting bone structure is removed to remove the tooth. This causes an elongation of both procedural and recovery times.

Attempts have been made to overcome the drawback of using forceps and elevators. For example, U.S. Pat. No. 4,230,454 discloses a tooth extractor that utilizes a vice type grip member having a joint member engaged by a forked end of a lever. The lever has a convexly curved fulcrum surface that rests against a planar base plate located on a patient's teeth that are adjacent to the tooth that is to be extracted. The grip member has two hemispherical tips for engaging correspondingly shaped indentations drilled in the buccal and lingual sides of the tooth.

U.S. Pat. No. 2,777,198 discloses a tooth extraction device that provides a minimum danger of injury to the tooth or to the jaw of a patient. The device uses a pair of forceps that are connected to an arm. Then, after the forceps are engaged with a tooth, a motor is activated to transmit a high-frequency vibration through the forceps to the tooth. The vibration causes the breakdown of the tissue surrounding the tooth, allowing for the slight upward or downward movement of the arm to remove the tooth from an upper or lower dental arch.

Further, U.S. Pat. No. 7,303,395 discloses an extractor that has a first and a second lever and a first and second branch pivotably connected to each other by a hinge. A rod for mechanically and manually adjusting the first and second levers is provided. An extracting part includes at least one resistance element for anchoring the tooth and consists of a first support for coupling with a receiving part of the first branch. A second support is placed against the extractor and has an opening for the extracting part.

None of the existing tooth extraction tools, such as dental forceps, luxators, root tip picks, and elevators, and those outlined in the above-cited prior arts, offer controlled, atraumatic extraction of a tooth. Conventional tools and procedures make use of force to stretch or rupture the periodontal ligament. It is thus desirable to have an improved tooth extraction tool that overcomes the problems and shortcomings of the prior art tools, or at least assists in tooth extraction efficiently and effectively by cutting through the periodontal ligament (PDL).

### SUMMARY

The present invention provides a tooth extraction or tooth loosening tool that allows tooth extraction of a subject tooth in a safe, convenient, and effective manner.

Using the proposed tooth extraction tool, the dentists directly sever the periodontal ligament (PDL) rather than relying on brute force to rupture it. The proposed method and tooth extraction tool allow dentists or clinicians to extract teeth with significantly reduced mechanical stress, thereby overcoming the shortcomings of the preexisting tooth extraction tools.

The tooth extraction tool of the present invention is designed to assist in procedures such as, but not limited to, weakening the PDL, such as tooth extractions, third molar extractions, root tip removal, and more.

The present invention provides a tooth extraction tool configured in the form of a knife with a flexible blade that can be inserted between the alveolar socket/bone and the tooth to be extracted, allowing for the cutting of the periodontal ligament (PDL) to facilitate the extraction process. Ideally, with this approach, a tooth can be “cut out” rather than forcibly extracted as in prior existing dental tools. Use of the presented tooth extraction tool and method allows the attachment force between the tooth and the alveolar bone to be reduced significantly, making the extraction a substantially more straightforward and uncomplicated procedure. Periodontal blade design of the tooth extraction tool and innovative cutting out of the PDL overcome all of the above-mentioned disadvantages of the conventional tooth extraction methods and tools.

According to various embodiments, the tooth extraction tool of the present invention comprises an elongated handle with a blade attached at one end of the handle. The blade is made substantially thin and is made of Nitinol or similar alloys that exhibit elastic properties and are biocompatible, allowing the blade to bend. The blade's elastic property enables it to flex and comply with the PDL space between the gum, which is curved with multiple radii. The super elastic property of the blade will also relay the axial force to the tooth to sever the PDL. The blade's design ensures the axial force is transferred to a vertical force or a lateral force to cut through the PDL. The handle comprises grooves formed on its outer surface for ease of gripping and carrying out a dental procedure.

The blade of the tooth extraction tool is designed for vertical motion to cut the PDL vertically. The blade cannot resist lateral force or cut the PDL laterally. Because of its flexibility, the blade requires supports for transferring vertical motion to the PDL for cutting action. Depending upon the location and accessibility of the tooth to be extracted, one can cut the PDL 360 degrees around the tooth, or just cut the PDL from accessible tooth surfaces around the tooth to release the tooth from the alveolar bone or socket. The flexibility of the blade and curvature not only allow tooth extraction, but also allow the extraction of root tips.

These and other features, advantages, and different embodiments of the present invention will become apparent from the detailed description below, in light of the accompanying drawings.

### BRIEF DESCRIPTION OF DRAWINGS

Other features and advantages of the invention will become clear from the following description and from the figures of the attached drawings, in which:

FIG. 1 illustrates a typical anatomical tooth model.

FIG. 2 illustrates a tooth extraction tool of the present invention, according to an embodiment of the present invention.

FIG. 3 illustrates an exploded view of the tooth extraction tool of FIG. 2.

FIGS. 4A-4C illustrates the shape and the flexibility of the blade of the tooth extraction tool, according to an embodiment.

FIGS. 5A-5C illustrate the movement of the flexible blade between an alveolar socket and a tooth to be extracted at one side of the tooth, allowing for the cutting of the periodontal ligament (PDL).

FIGS. 6A-6B illustrate the movement of the flexible blade between the alveolar socket and the tooth on the other side for further cutting of the PDL.

FIG. 7 shows a tooth extraction process with the flexible blade being supported with a finger for transferring vertical motion to the PDL for cutting action, according to an embodiment.

FIGS. 8A-8D illustrate different shapes of the flexible blade, according to various embodiments.

FIGS. 9A-9C illustrate tooth extraction tool of the present invention according to various alternative embodiments.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

References to “one embodiment”, “an embodiment”, “another embodiment”, “an example”, “another example”, “alternative embodiment”, “some embodiment”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

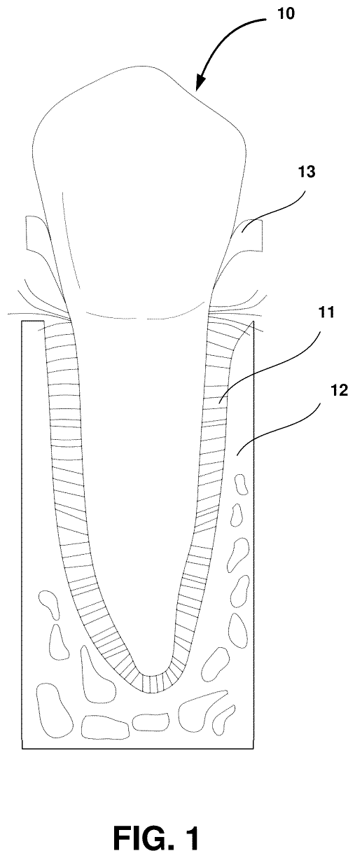

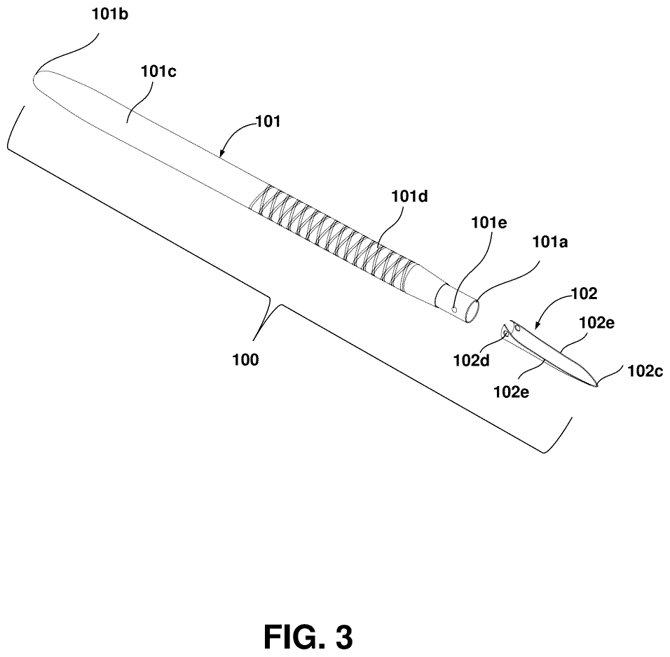

The proposed tooth extraction tool and associated method allow cutting through the PDL that attaches teeth to the alveolar bone, significantly reducing the tooth's attachment force with the alveolar bone to enable a more controlled, atraumatic extraction of the subject tooth. The various features and embodiments of the present invention are better explained in conjunction with FIGS. 1-9.

FIG. 1 illustrates a typical anatomical tooth model. The figure explicitly shows how various structures support the tooth to ensure the tooth remains stable and functional. As seen, the key structures supporting tooth 10 are the periodontal ligament (PDL) 11, the alveolar bone 12, and gums (gingiva) 13. The PDL 11 is a group of connective tissues that attach the tooth 10 to the jawbone. It acts like a shock absorber, cushioning the tooth 10 during chewing and biting to prevent damage. It helps attach the tooth 10 to the alveolar bone 12. The alveolar bone 12 is the part of the jawbone that holds the tooth in place. It's essential for maintaining tooth stability. The gums 13 are the soft tissue that surrounds the teeth, covering the roots and protecting them from bacteria. Traditionally, a dentist first locates a tooth to be extracted and then gives local anesthetics to numb the area around the tooth (for painless extraction). Once the area surrounding the tooth 10 is made numb, the dentists use special tools such as forceps, luxators, root tip picks, and elevators to loosen the tooth and pull it out of the tooth socket. Post extraction, the procedure to stop bleeding from the socket is carried out. The use of such tooth extraction devices is often associated with pain and unpleasantness because the dentist needs to apply force to overcome the attachment force of the tooth to the socket or alveolar bone 12. Tooth 10 is attached to the socket using the PDL 11. Depending upon the condition of the tooth to be extracted, the force applied may be less or more. Also, the extraction process carried out using forceps (pliers) is usually a rotational motion, followed by linear movement. The extraction process typically causes pain. Despite the application of anesthetics, patients may still experience pain, and the pain increases post-surgery.

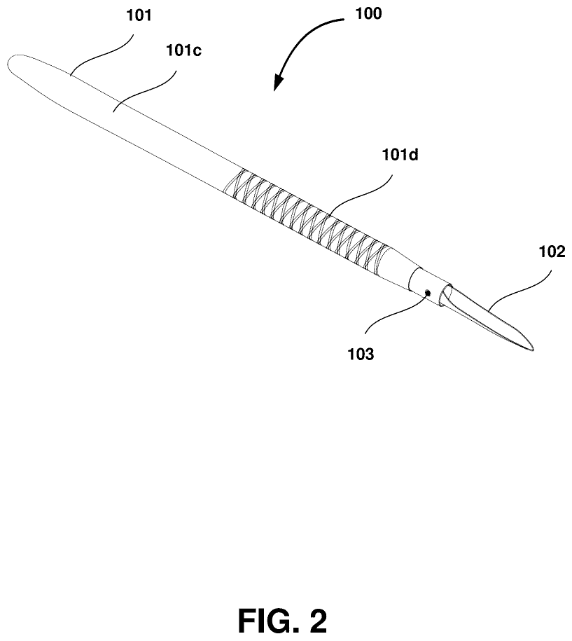

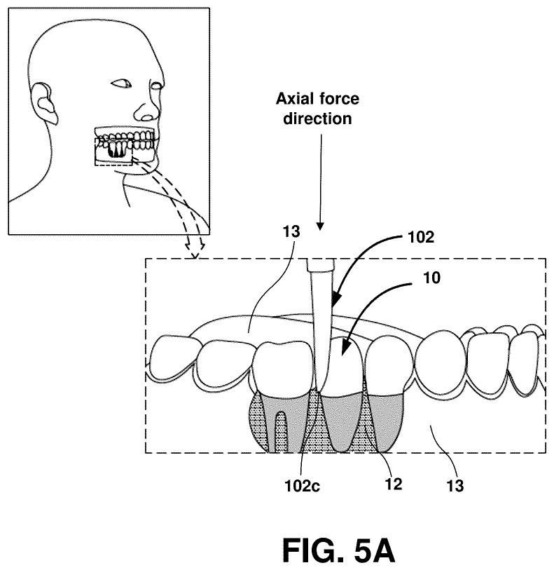

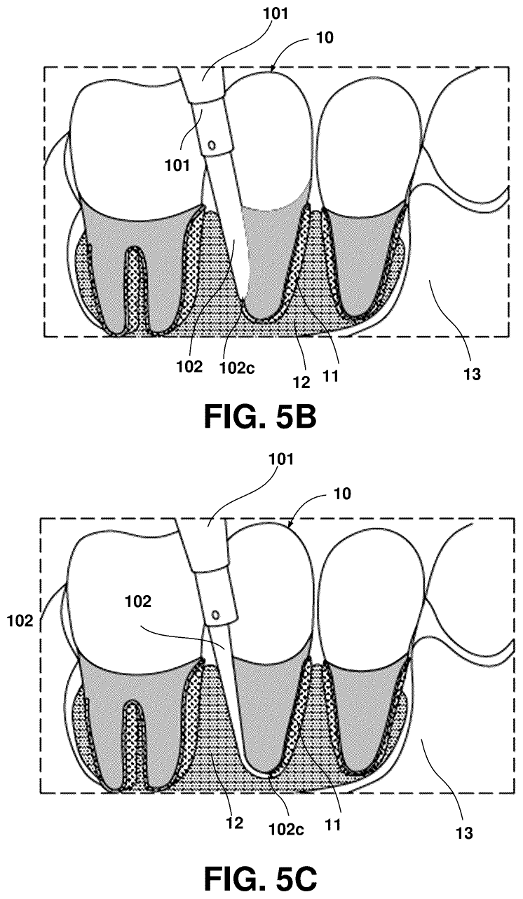

Referring to FIGS. 2-3, 4A-4C, along with FIGS. 5-9, illustrate the tooth extraction tool 100, according to one embodiment of the present invention. The tooth extraction tool 100 comprises an elongated handle 101, and a blade 102. The handle 101 includes a first end 101a and a second end 101b. The handle 101 includes an outer surface 101c. The outer surface 101c may include grooves 101d for making the gripping of the tool 100 more convenient for a dentist/user. The handle 101 may be configured in various shapes, such as but not limited to cylindrical shape, cylindrical shape with tapered end (one or both ends), flat/tapered body flat all along the length of the handle 101. The first end 101a of the handle 101 includes a first connecting feature 101c.

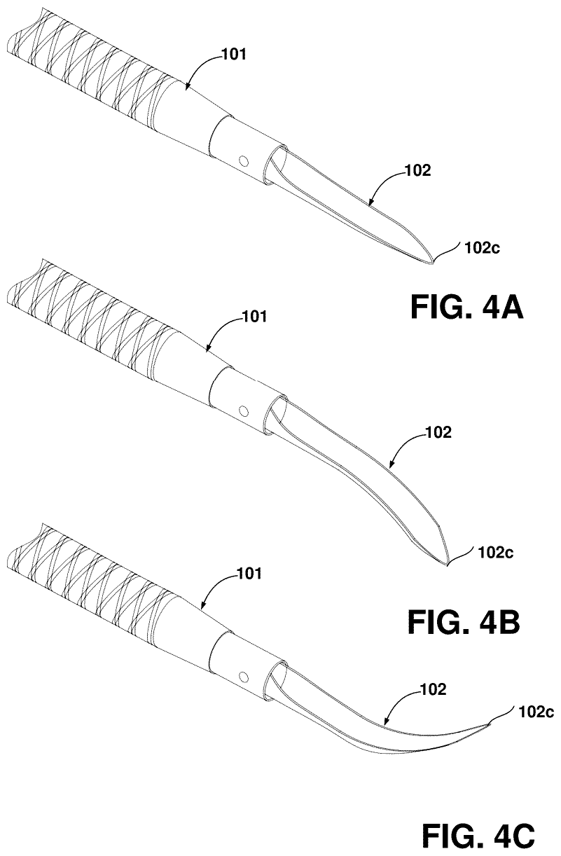

According to various embodiments, the blade 102 is made out of an elastic material such as Nitinol. The material of the blade 102 can be any shape memory alloy (Nitinol) that can adapt to the shape of the PDL space between the tooth 10 and the alveolar bone 12. The shape memory alloy (Nitinol) exhibits elasticity at a temperature ranging from −20° C. to 40° C. Consequently, the blade 102 is able to bend and regain its shape. Due to the elastic nature of the blade 102, the blade 102 can flex at any point along its length and in any direction, as shown in FIGS. 4A, 4B, and 4C. FIG. 4A shows the unflexed condition of the blade 102. FIG. 4B shows the blade 102 flexed backward. FIG. 4C shows the blade 102 flexed in the forward direction. The blade 102 may be made of different widths, thicknesses, and axial diameters to provide flexibility in accessing the PDL. FIGS. 5A-5C,6A-6B demonstrates how flexible blade 102 accesses the PDL space. The super elastic property of the blade 102 enables it to transform the vertical force for cutting the PDL space and to be flexible, adapting to the curvature of the tooth's root.

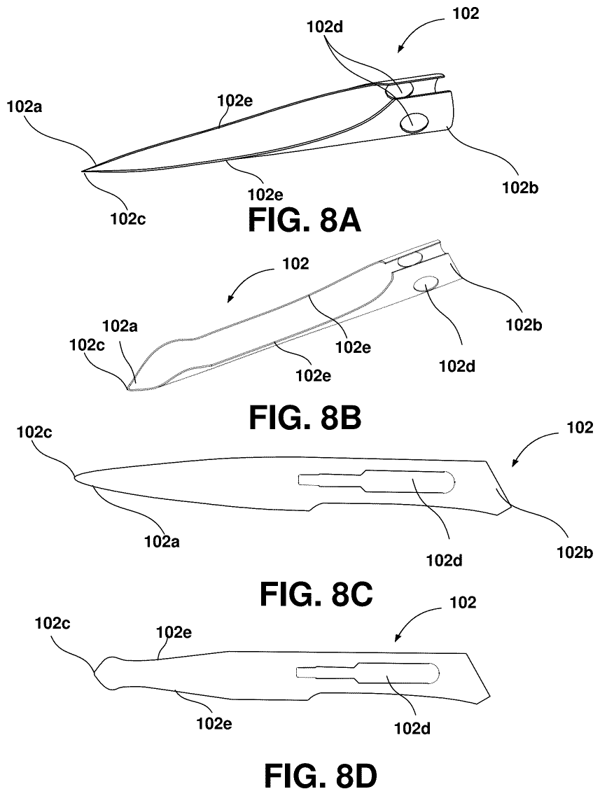

As seen in FIGS. 8A-8D, the blade 102 may be formed in many different shapes and dimensions. According to various embodiments, the blade 102 can be flat or cylindrically round/curved (like a pencil) with a diameter from 2 to 15 mm. During the manufacturing process of the blade 102, the user can use a metal sheet and heat to form a cylindrical shape of blade 102 out of the metal sheet. In some other processes, one can directly cut from a tube to form the blade 102 in the desired shape. In an embodiment, the blade 102 is shaped as a conic section or frustum section. The length of the blade 102 may range from 5 mm to 100 mm. In an embodiment, the blade 102 can have sufficient length to reach the apical tip of the root but without being interfered with by the crown of the tooth. The length is measured from distal to mesial. The blade 102 may include a thickness ranging from 0.01 mm to 1 mm. The neck area of the blade 102 may be thicker or thinner compared to the rest of the blade's body. In some embodiments, the neck area of the blade 102 may be identical in thickness to the rest of the blade's body. The thicker neck area of the blade 102 is designed to deliver vertical force, thereby limiting buckling, fatigue, and damage, and to facilitate the transfer of vertical force into lateral force for cutting the PDL. Having a thinner neck area than the tip may be useful to deliver force laterally during vertical movements with lateral force on the blade 102. The blade 102 may include a width (proximal to proximal) of 2 mm to 20 mm.

FIG. 8A shows explicitly the blade 102 with a sharp anchor point 102c. The blade 102 includes a proximal end 102a and a distal end 102b. The proximal end 102a comprises a sharp, pointed tip 102c that can assist in anchoring the tool 100 at a targeted site for an initial incision. The distal end 102b comprises a second connecting feature 102d that couples or connects to the first connecting feature 101e of the handle 101. The blade 102 of FIG. 8A may be partially cylindrical from its two edges 102e (at the distal end 102b). Referring to FIG. 8B, the blade 102 is shown to have a proximal end 102a and a distal end 102b. The blade 102 includes a connecting feature 102d that couples to the first connecting feature 101e of the handle 101. The proximal end 102a consists of a tip 102c, and the body is more curved in proximity to the distal end 102b and the proximal end 102a. In this embodiment, the blades' lateral edges 102e are cut. FIG. 8C shows another exemplary blade 102 that's substantially flat (non-cylindrical and non-curved). The blade 102 of this embodiment also includes a proximal end 102a and a distal end 102b. The blade 102 includes a connecting feature 102d that essentially connects to the handle 102. FIG. 8D shows a flat blade 102, as shown in FIG. 8C, but with lateral cuts at its lateral edges 102e and connecting features 102d. The blades with lateral cuts may be useful for accessing specific teeth as the blades without lateral cuts may not be suitable for all categories of teeth. The blades 102 with the second connecting features 102d couple to the connecting features 101e of the handle 101. In an example, the connecting features are holes. The holes 101e present at the first end of the handle 101 are aligned with the holes 102d of the blade 102, and then a pin or suitable fastener 103 (FIG. 2) is inserted into the holes 102d, 101e to couple them together immovably. This method of connecting the blade 102 to the handle 101 is exemplary. In some other embodiments, the distal end 102b of the blade 102 may snap fit into the first end 101a of the handle 101. It might also be possible that the blade 102 may be fixedly attached at the first end 101a of the handle 101 in accordance with some other embodiment. The configuration of the blade 102 into various shapes is focused on delivering vertical and lateral force to the PDL, such as to weaken the force that helps the PDL to connect the tooth to the alveolar bone.

According to various embodiments, the surface finish of the material used for the blade 101 can be electropolished, chemically etched, or mechanically polished to exhibit biocompatibility, safety, and efficacy. Also, the blade 102 can be sterilized to exhibit patient safety. Further, the blade 102 can be packaged in a porous Tyvek pouch, a metal sleeve, or any other packaging material to prevent penetration and to maintain a sterile field.

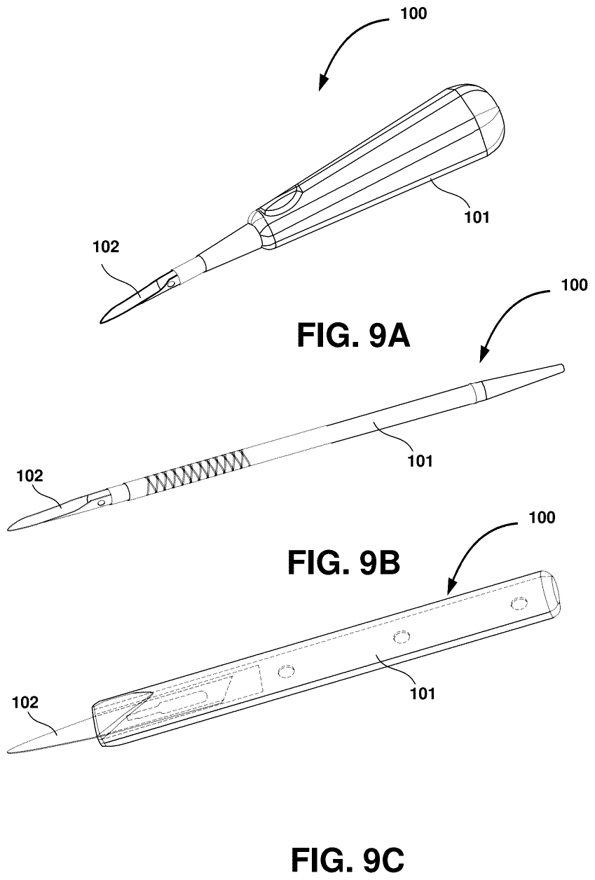

FIGS. 9A-9C illustrates different forms of the tooth extraction tool 100, according to various embodiments. Specifically, FIG. 9A shows the blade 102 of FIG. 8A connected to an ergonomic and reinforced handle 101. The reinforced handle 101 reduces strain on the user's hands and wrists, improving overall usability and productivity. The shape and contour of the handle 102 significantly impact its ergonomic qualities. FIG. 9B essentially shows the extraction tool 100 with the blade of FIG. 8A presented in FIG. 2, except that the handle 102 is thinner in diameter. FIG. 9C essentially shows the tool 100 with a blade extension mechanism (for extending or ejecting the blade out of the handle) that may use blades shown in FIGS. 8C-8D. Depending on the position of the tooth to be extracted, the dentist may use different blade designs or tools. It should be noted that handles may be designed in many different forms that include the flexible blade 102. While manufacturing the handles, they should be designed with contours that match the natural curvature of the hand, allowing for a secure grip without excessive force. Also, handles with rounded edges and smooth transitions between grip zones prevent pressure points and discomfort during operation. The that better fits in the hand promotes natural movements and reduces the risk of injury or fatigue over prolonged. Accordingly, the handle 102 may be designed.

Referring back to FIG. 1, which shows the biomechanics of tooth attachment. In a non-pathological state, the tooth 10 is anchored to the alveolar bone 12 via the periodontal ligament (PDL) 11. The required force to overcome this attachment is given by:
Wherein,

$${F}_{attachment} = {A}_{socket} \times {σ}_{PDL}$$

Wherein,
F_{attachment}=total force required to overcome the PDL attachment
A_{socket}=total surface area of the socket-tooth interface
σ_{PDL}=yield strength of the PDL (a material property)

To successfully extract a tooth, the applied extraction force by a dentist must exceed this attachment force:

$${F}_{Extraction} ≫ {F}_{attachment} {=}_{FApplied to tooth} = {F}_{Applied to bone}$$

According to Newton's third law, the force applied to the tooth is simultaneously transmitted to the surrounding bone. In ideal cases—where both bone and tooth are healthy—this is not problematic. However, in clinical practice, this is rarely the case. Many extractions involve teeth with compromised structural integrity (caries, root canal treatment, cracks) and the need to preserve surrounding bones, particularly in the esthetic zone for future implant placement. In these situations, excessive force increases the risk of fracture or bone loss. However, the use of the proposed tooth extraction tool 100 is designed to mitigate such risks.

The proposed tooth extraction tool 100 does not apply force to stretch or rupture the PDL 11, rather, the tool 100 with the flexible blade 102 is designed to cut or sever through the PDL 11, significantly reducing the tooth's attachment force. The clinicians or dentists are able to extract teeth with lesser force, greater control, and minimal trauma.

The proposed tooth extraction tool 100 with a flexible blade 102 is adapted to sever the PDL at various depths. Cutting the PDL even by a smaller depth results in a drastic reduction of the surface area and force of extraction. Table 1 below shows experimental/use case values demonstrating how much force reduction for extracting teeth can be achieved using tooth extraction tool 100.

To know about the efficiency of the proposed tool 100, consider a worst-case scenario:
Socket diameter: 10 mm (larger than most roots)
Root length: 15 mm
Total PDL surface area (full length): 376.29 mm²

Assuming various depths severed by the tool 100, the surface area and force reduction are as follows (Table 1):

| | Remaining | % Force | % Extraction |
|---|---|---|---|
| PDL Cut Depth | Surface Area | Reduction | Force Required |
| 0 mm | 376.29 mm² | 0% | 100% |
| (Conventional) | | | |
| 5 mm | 222.95 mm² | 41% | 59% |
| 10 mm | 89.53 mm² | 76% | 24% |
| 12 mm (Optimal) | 46.32 mm² | 88% | 12% |

The values in Table 1 above show that even partial severing of the PDL using the proposed tool 100 can lead to a dramatic reduction in the extraction force required to extract the subject tooth 10. As the extraction force reduces, there is less stress on the bone and a lower risk of complications compared to using conventional tooth extraction tools.

As already described above, the tooth extraction tool 100 of the present invention features an elongated handle 101 attached to a precision-engineered flexible blade 102 made from a specially programmed shape memory alloy. This elastic material and design combination allows optimal performance and flexibility within the periodontal space. The blade's geometry is specifically engineered to: conform to the natural curvature of the PDL 11, maximize vertical load transfer, and minimize trauma to surrounding tissues. Carefully calibrated thickness of the blade 102 allows smooth and accurate access to the PDL space, preserving adjacent bone and gingiva associated with the tooth to be extracted.

In operation, referring to FIGS. 5A-5C,6A-6B and 7 along with FIGS. 2-4, a clinician/dentist holds/grips the handle 101 with his fingers just like a conventional pen. Because of the flexibility, the blade 102 requires a finger support for transferring vertical motion to the PDL 11 for cutting action.

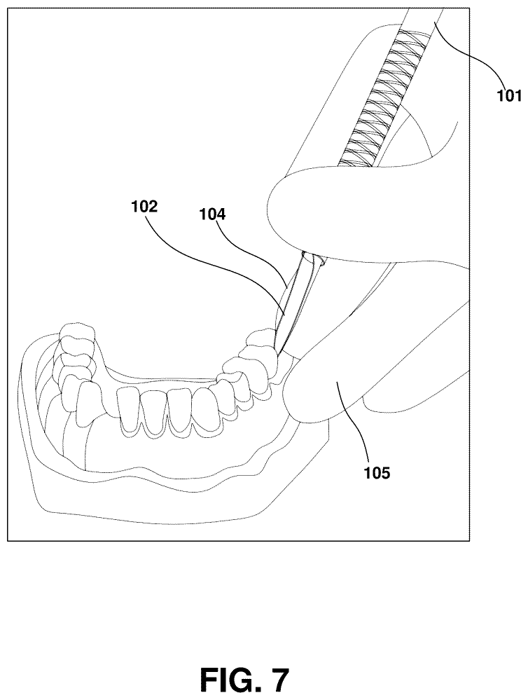

As best seen in FIG. 7, the dentist holds the handle 101 and supports rear side of the blade 102 using his middle finger 104 (to prevent the blade from being bent or being flexed) to make initial incision and carry out cutting of PDL 11 on multiple sides of the tooth 10 and the fourth finger (ring finger) 105 is optionally attached to the surgical site for necessary further support. The dentist preferably supports the blade 102 using the third finger 104 near to the blade's tip 102c. The support from the middle finger 104 ensures the vertical force of the dentist is transferred to PDL 11.

Depending upon the location and category of the tooth 10 to be extracted, the dentist may vertically insert the blade 102 (with the tip 102c) into the PDL 11 along various surfaces such as buccal surface, lingual surface, palatal surface, occlusal surface, proximal surface of the tooth 10 (as may be understood from FIG. 5A). It should be noted that, it is not necessary that using the blade 102, the dentist needs to cut the PDL 11 all around 360 degrees. The dentist can choose to insert the blade 102 into the accessible selective surfaces of the tooth 10 to cut through/sever the PDL space and separate the tooth 10.

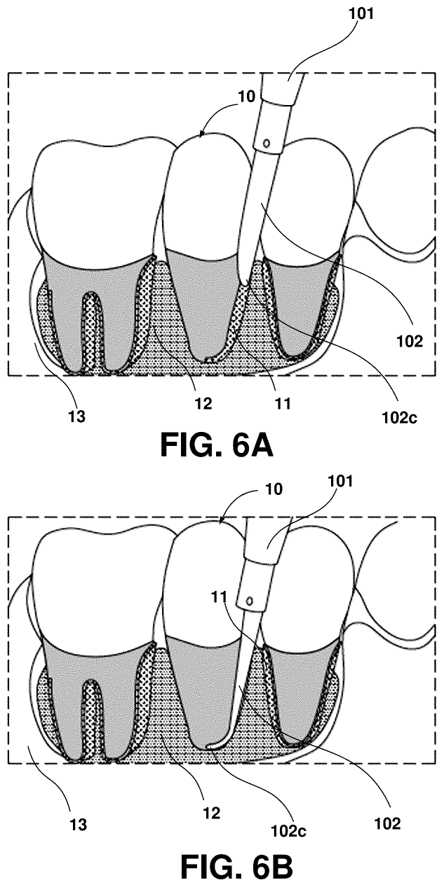

After the blade 102 is initially vertically moved on any tooth's surfaces (FIG. 5A or FIG. 7), the continued vertical motion of the blade 102, allows the tip 102c of the blade 102 to advance within the PDL and apply vertical force, and the blade 102 bends and adapts to the curvature of the tooth's root to cut the PDL 11. FIGS. 5B and 5C show the blade 102 being adapted to the curvature of the tooth's root due to the blade 102 being flexible or having elasticity along one of the tooth's surfaces. Once the PDL 11 at one side of the tooth is cut or severed, the blade 102 is reinserted along another surface of the tooth 10 to cut the PDL 11 as seen in FIGS. 6A and 6B.

Next, once the procedure to cut the PDL 11 is completed from all around the tooth 10 or from selected surfaces, the tooth 10 is then easily extracted using any conventional pulling tool. Due to the cutting of the PDL 11, the force required to extract tooth 10 from the alveolar socket is significantly reduced, and the patient doesn't have to go through significant pain.

The handle 101 and blade 102 of the tool 100 may be configured in many different shapes and sizes, and may be made of a variety of materials. It should be understood that specific mention about the material and shapes for the handle and blade, and the nature of their connections, should not be considered as a limitation for the purpose of this disclosure.

The preceding description has been presented with reference to various embodiments. Persons skilled in the art and technology to which this application pertains will appreciate that alterations and changes in the described structures and methods/steps of operation can be practiced without meaningfully departing from the principle, spirit and scope of the present invention.

1. A tooth extraction tool (100) configured to sever through a periodontal ligament (PDL) (11) for atraumatic extraction of a tooth (10), comprising:
an elongated handle (101) with a first end (101a), and a second end (101b); and
a blade (102) attached to the first end (101a) of the elongated handle (101), the blade (102) flexes to adapt to the shape of the periodontal ligament (PDL) when the blade (102) is vertically moved between alveolar bone (12) and the tooth (10) to be extracted along selected tooth surfaces, and wherein the vertical movement of the blade (102) relays an axial force to sever the PDL (11).

2. The tooth extraction tool (100) of claim 1, wherein the handle (101) further includes a plurality of grooves (101d) configured on an outer surface (101c) for providing a better grip of the tooth extraction tool (100).

3. The tooth extraction tool (100) of claim 1, wherein the first end (101a) of the handle (101) includes a first connecting feature (101e) that facilitates connection to a second connecting feature (102d) of the blade (102).

4. The tooth extraction tool (100) of claim 1, wherein the blade (102) is made of shape memory alloy with an elastic property allowing the blade (102) to flex to adapt to the shape of the periodontal ligament (PDL) space between the alveolar bone (12) and the tooth (10).

5. The tooth extraction tool (100) of claim 4, wherein the shape memory alloy used for the formation of the blade (102) is Nitinol that exhibits an elasticity at a temperature ranging from −20° C. to 40° C.

6. The tooth extraction tool (100) of claim 1, wherein the blade (102) is made at least one of: a flat, partially cylindrical, or cylindrically curved along its entire length with a diameter ranging from 2 to 15 mm.

7. The tooth extraction tool (100) of claim 1, wherein the cylindrically curved blade (102) includes a pair of laterally cut edges (102e).

8. The tooth extraction tool (100) of claim 1, wherein the blade (102) comprises a length ranging from 5 mm to 100 mm sufficient to reach an apical tip of the tooth's root.

9. The tooth extraction tool (100) of claim 1, wherein the blade (102) comprises a width ranging from 2 mm to 20 mm.

10. The tooth extraction tool (100) of claim 1, wherein the thickness of the blade (102) ranges from 0.01 mm to 1 mm.

11. The tooth extraction tool (100) of claim 1, wherein the thickness of the neck area of the blade (102) is different compared to the rest of the blade's body for:
delivering vertical force limiting buckling, fatigue, and damage;
facilitating the transfer of vertical force into lateral force for cutting the PDL (11); and
delivering force laterally during vertical movement of the blade (102).

12. The tooth extraction tool (100) of claim 1, wherein the proximal end (102a) of the blade comprises a pointed tip (102c) that allows the tooth extraction tool (100) to be anchored at a targeted site for an initial incision before the insertion of the tooth extraction tool (100) in the PDL space.

13. The tooth extraction tool (100) of claim 1, wherein the second end (102b) of the blade (102) snap fits to the first end (101a) of the handle (101) to form a secure attachment.

14. The tooth extraction tool (100) of claim 3, wherein the first connecting feature (101e) of the handle (101) and the second connecting feature (102d) of the blade (102) are connected using a fastener (103).

15. The tooth extraction tool (100) of claim 14, wherein the first and second connecting features (101e, 102d) are holes and the fastener (103) is a pin.

16. The tooth extraction tool (100) of claim 1, wherein the blade (102) is shaped as a conic section or a frustum section.

17. A tooth extraction tool (100), comprising:
an elongated handle (101) with a first end (101a), and a second end (101b), wherein the first end (101a) of the handle (101) comprises a first connecting feature (101e);
a blade (102) comprising a first end (102a) and a second end (102b), wherein the second end (102b) of the blade (102) comprises a second connecting feature (102d);
wherein, the first connecting feature (101e) of the handle (101) and the second connecting feature (102d) of the blade (102) are connected using a fastener (103); and
wherein, the blade (102) when vertically moved along selected tooth surfaces of a tooth 10 to be extracted, the blade (102) adapts to the shape of a periodontal ligament (PDL) 11 and relays an axial force to sever the PDL (11).

18. The tooth extraction tool (100) of claim 17, wherein the first connecting feature (101e) of the handle (101) and the second connecting feature (102d) of the blade (102) are holes, and the fastener is a pin.

19. The tooth extraction tool (100) of claim 17, wherein the blade (102) is made of a shape memory alloy with an elastic property allowing the blade (102) to flex to adapt to the shape of the periodontal ligament (PDL) space between the alveolar bone (12) and the tooth (10).

20. The tooth extraction tool (100) of claim 17, wherein the shape memory alloy comprises Nitinol exhibiting elasticity at a temperature ranging from −20° C. to 40° C.

21. The tooth extraction tool (100) of claim 17, wherein the blade (102) is shaped as a conic section or frustum section.

22. A method of tooth extraction, the method comprising:
gripping a handle (101) of a tooth extraction tool (100);
vertically moving a blade (102) of the tooth extraction tool (100) along selected tooth surfaces of a tooth (10) to be extracted between the tooth (10) and an alveolar bone (12), wherein the blade (102) adapts to the shape of a periodontal ligament (PDL) (11) during the vertical movement; and
relaying an axial force to sever the PDL (11) by the blade (102) severing through the PDL (11).

23. The method of claim 22, wherein the step of vertical movement of the blade 102 is supported by one of the fingers of a dentist carrying out the extraction procedure to prevent the blade (102) from being bent.

24. The method of claim 22, wherein the blade (102) is made of a shape memory alloy with an elastic property allowing the blade (102) to bend to adapt to the shape of the periodontal ligament (PDL) space between the alveolar bone (12) and the tooth (10).

25. The method of claim 24, wherein the shape memory alloy comprises Nitinol that exhibits an elasticity at a temperature ranging from −20° C. to 40° C.

26. The method of claim 22, wherein the blade (102) is shaped as a conic section or frustum section.
